(19) United States
(12) Patent Application Publication
(10) Pub. No.: US 2013/0166342 A1
(43) Pub. Date: Jun. 27, 2013

(54) Method and Apparatus for Computer Based Process Monitoring and Control

(71) Applicants: Andrew Speier Fradkin, Dearborn, MI (US); Nathan Stephen Whitehead, Dearborn Heights, MI (US); Flournoy Evans Henry, Hamilton, GA (US)

(72) Inventors: Andrew Speier Fradkin, Dearborn, MI (US); Nathan Stephen Whitehead, Dearborn Heights, MI (US); Flournoy Evans Henry, Hamilton, GA (US)

(73) Assignee: FORD MOTOR COMPANY, Dearborn, MI (US)

(21) Appl. No.: 13/332,565

(22) Filed: Dec. 21, 2011

(51) Int. Cl. G06Q 10/06

(52) U.S. Cl. 705/7.15; 705/7.13

(57) ABSTRACT

A computerized method for monitoring business processes is exemplified. Business process data and task data are stored in memory of a computer. The method further includes receiving a data request from a requesting party. The method additionally includes filtering business process data and task data based on the role of the requesting party. A first requesting party has a first monitoring role is designated a level of access limited to viewing task data for fewer than all tasks. A second requesting party has a second monitoring role is designated a level of access as viewing or editing task data limited to fewer than all tasks. A third requesting party has a third monitoring role is designated a level of access as viewing or editing task data for all tasks. The method furthermore includes returning the requested data to the requesting party based on the user credentials of the requesting party.

### TECHNICAL FIELD

The illustrative embodiments generally relate to a method and apparatus for computer based process monitoring and control.

### BACKGROUND

Business process management is a holistic management approach focused on aligning all aspects of an organization with the wants and needs of clients and/or customers. Business process management allows businesses to be effective and efficient while striving for innovation, flexibility, and integration with technology. Business process management also stresses the continuous improvement of each process. Business process management can allow entities to be more efficient, effective, and capable of change than a functionally focused, traditional hierarchal management approach. Overall, business process management helps organizations gain higher customer satisfaction, product quality, delivery speed, and/or time to market speed.

### SUMMARY

In a first illustrative embodiment, a computerized method for monitoring business processes is exemplified. Business process data relating to the business processes and task data correlated to related business process data are stored in the memory of a computer system, tasks related to the task data having one or more task completion parties assigned to complete respective tasks associated therewith. The method further includes receiving a data request from a requesting party who is not one of the task completion parties assigned to complete any of the tasks correlated to a related business process for which the data request was made. The method additionally includes filtering business process data and task data based at least in part on the role of the requesting party. A first requesting party has a first monitoring role is designated a first level of access limited to viewing of task data for fewer than all tasks correlated to the respective business process. A second requesting party has a second monitoring role is designated a second level of access as viewing or editing task data limited to fewer than all tasks correlated to the respective business process. A third requesting party has a third monitoring role is designated a third level of access as viewing or editing task data for all tasks correlated to the respective business process. The method furthermore includes returning the requested data to the requesting party based upon the requested data meets the level of access designated to the requesting party based on the user credentials defining the role of the requesting party.

In a second illustrative embodiment, a computerized system for monitoring business process management is exemplified. The system includes an electronic storage device including business process data and task data correlated to related process data and defining tasks to complete one or more business processes. The tasks having one or more task completion parties assigned to complete the respective tasks. The system further includes a processor configured to execute one or more applications. The system further includes a non-transitory application stored in memory. When the application is executed by the processor the application is configured to receive a data request from a requesting party, including on or more user credentials designating role for the requesting party. Furthermore, the application is capable of filtering business process data and task data based at least in part on the role of the requesting party. A first requesting party has a first monitoring role designating a first level of access limited to viewing of task data for fewer than all tasks correlated to the respective business process. A second requesting party has a second monitoring role designating a second level of access as viewing or editing task data limited to fewer than all tasks correlated to the respective business process. A third requesting party has a third monitoring role designating a third level of access of viewing or editing task data for all tasks correlated to the respective business process. Furthermore, the application is capable of returning the requested data to the requesting party based upon the requested data meeting the level of access designated to the requesting party based on the user credentials defining the role of the requesting party.

In a third illustrative embodiment, a non-transitory computer readable storage medium storing business process data and task data correlated to related process data and defining tasks to complete one or more business process. The tasks having one or more task completion parties assigned to complete the respective tasks associated therewith, and storing instructions that when executed by a processor causes the processor to perform a method. The method includes receiving a data request from a requesting party who is not one of the task completion parties assigned to complete any of the tasks correlated to a related business process for which the data request was made, the data request including one or more user credentials designating a role of the requesting party. The method additionally includes filtering business process data and task data based at least in part on the role of the requesting party. A first requesting party having a first monitoring role is designated a first level of access limited to viewing of task data for fewer than all tasks correlated to the respective business process. A second requesting party having a second monitoring role is designated a second level of access as viewing or editing task data limited to fewer than all tasks correlated to the respective business process. A third requesting party having a third monitoring role is designated a third level of access as viewing or editing task data for all tasks correlated to the respective business process. The method further includes returning the requested data to the requesting party based upon the requested data meets the level of access designated for the requesting party based on the user credentials defining the role of the requesting party.

### BRIEF DESCRIPTION OF THE DRAWINGS

FIG. 1 shows a hardware and application diagram of an illustrative business process management computer system.

FIG. 2A shows an illustrative flowchart of operations in a business process management system;

FIG. 2B shows an illustrative flowchart of control and monitoring rights in a business process management system.

FIG. 3 shows an illustrative graphical user interface displaying a task query of the business process management system;

FIG. 4 shows an illustrative graphical user interface displaying the details of task data associated with the business process data; and

FIG. 5 shows an illustrative flowchart depicting task data associating with the process data.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The invention now will be described more fully hereinafter with reference to the accompanying drawings, in which illustrative embodiments of the invention are shown. This invention, may however, be embodied in many different forms and should not be construed as limited to the embodiments set forth herein. Like numbers refer to elements throughout. As used herein the term “and/or” includes any and all combinations of one or more of the associated listed items.

The processes described illustratively herein can be implemented as computer code stored on a machine readable storage medium and executed by a processor. Storage medium include, but are not limited to, HDD, CDs, DVDs, RAM, ROM, flash drives, or any other suitable storage medium.

In one illustrative embodiment, the business process management system allows entities to provide, for example, without limitation, security, accessibility, management, control, and filtering of business processes throughout an entity. The business processes can be any activity in which an entity is involved. In one example, the business process can be an internal process which is conducted within one entity. The business process can also be an external process which may involve many different suppliers, manufacturers, consultants, contractors, or any other outside organization. The business processes involved can also be in one geographic location or be conducted throughout many different geographic regions. For example, without limitation, the business process can involve the manufacturing of a multimedia system by several suppliers for an automotive manufacturer. In another example, the business process can involve an employee's review of their performance by different levels of management through a corporation. Exemplary business processes are not limited to a specific industry or type of process, and the examples set forth herein are for illustrative purposes only.

In one illustrative embodiment, the business process management system may associate task data with the different business process data. The association of task data with different business process data allows each user within a given business process to understand the individual tasks involved in the whole business process. Additionally, it allows individual users to understand specific tasks that they must complete to successfully complete their portion of a business process, which, in some instances, may be the entire process.

In another illustrative embodiment, the business process management system is capable of filtering process data and task data. When a user is viewing and analyzing different process data and task data, filtering of certain data may allow a user to efficiently complete an assignment. Accordingly, the business process management system has the capability of filtering out certain process data and task data. Additionally, filtering can provide a layer of security, by only allowing specific users to see and/or edit data relating to tasks assigned to those users.

For example, without limitation, a process-creating user and/or an administrative level user may be able to edit and view all aspects of an input process. Such editorial capacity may correspond, for example, to a management role in the process. An individual, such as, but not limited, to, an engineer or a contractor, may only be able to see and/or edit elements of the process that are specifically assigned to that individual. This tiering can be multi-layered and can provide selective and secure access to task elements and other elements associated with a business process structure.

By providing selective access, in one embodiment, users are prevented from altering data for which they do not have access or ownership. Individuals involved in certain elements of the process may also be able to see other elements which they may not edit, while having editing capability restricted to elements over which they have some level of ownership or control. This can help by providing both security and streamlining.

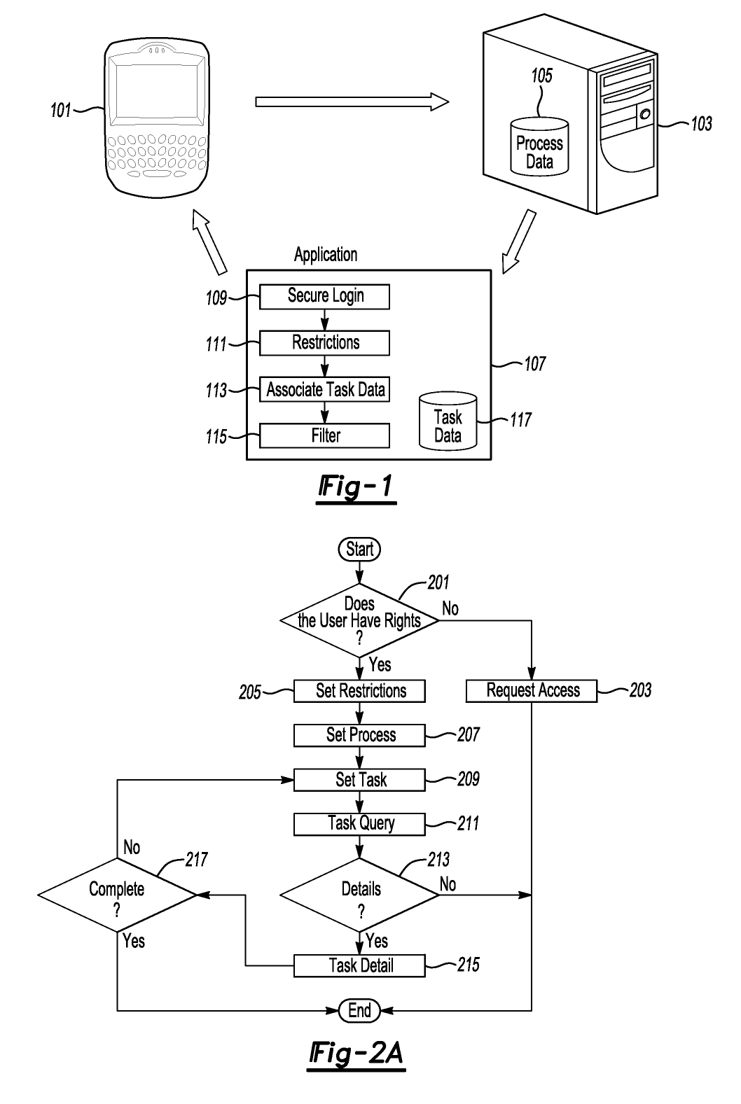

Referring now to FIG. 1, one exemplary business process management system is illustrated at a high level. In the exemplary embodiment shown, an electronic device 101 (such as, but not limited to, a workstation, PC, mobile device, etc.) allows users to receive business process data 105 (stored, for example, in a database) of business process for viewing and/or alteration. The electronic device 101 can connect to one or more remote servers 103, either wired or wirelessly. The electronic device 101 can share input and output with the servers 103. In one illustrative embodiment, the electronic device can update the server with new business process data 105 and the server can output to the electronic device the latest task data 117 associated with the new business process data 105.

The servers 103 are configured to communicate with the electronic devices 101. The servers 103 can also collect any input regarding process data from the electronic device. The servers are also configured to store the process data 105 and task data 117.

Business process data 105 may contain details concerning different processes within an entity. Business process data may contain attributes regarding a process within an entity, for example, without limitation, procedures, methods, contacts, schedules, status, etc. In one illustrative example, business process data of manufacturer's design group may include various steps, facts, due dates, tasks, etc. in designing a part. In another non-limiting example, business process data may include the various factors for hiring an employee, such as, but not limited to, deadlines, procedures, responsible individuals, etc.

The servers 103 can also act as storage for an illustrative application 107. The servers 103 are capable of inputting and outputting data in conjunction with the application 107. The application 107 may be non-transitory and stored in a memory portion of the server 103. The application 107 may serve as an interface with the user to interact with business process data 105. Additionally, the application 107 may be configured to apply a secure log in 109, set restrictions 111 on certain data, associate 113 the task data 117, and filter 115 any data. The application 107 can communicate with the electronic device. The user can input/output data to/from the application 107 by utilizing the electronic device's input.

The application may be developed and process enabled using a development language such as, but not limited to, Java, C, or Ruby on Rails. Likewise, the application could be developed using a Business Process Management Suite such as, but not limited to, Lombardi Teamworks or IBM BPM. In one example, the application may run inside a J2EE application server through a Java Virtual Machine. The application may be capable of running in a Unix, Linux, or Windows operating system using application servers, such as, but not limited to, JBOSS, WebLogic, or WebSphere. Additionally, the application may be non-transitory in itself, or stored on a non-transitory computer readable storage medium or memory.

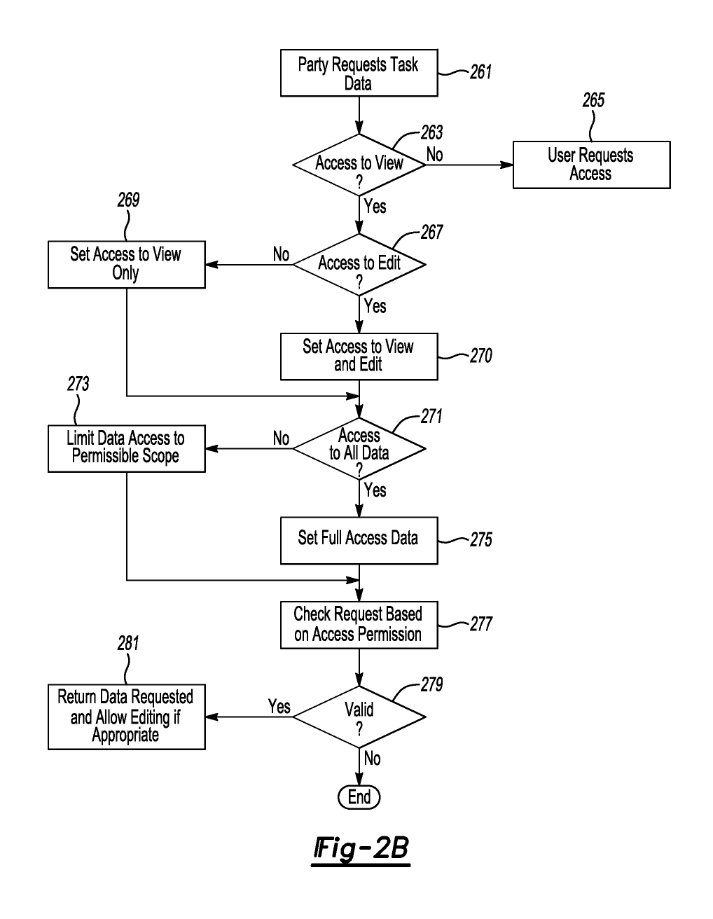

Referring now to FIG. 2A, the flowchart shows different, illustrative operations incorporating the use of an exemplary business process management system according to one illustrative embodiment. As illustrated, the flow chart analyzes the user's rights 201, grants or denies access, sets restrictions 205, sets process 207, sets tasks 209, allows a task query 211, and displays task detail 215. When a user logs in to the business process management system, they may do so by a user name and password, unique ID, biometric scan, RF scan, secured near-field communication, or other secure log in. If the user has no access rights to the business process management system, they are prevented from accessing the business process management system altogether.

A user without access rights to a particular process (or to the system as a whole) may request log-in credentials 203 from an administrator.

If a user has access rights to the business process management system, the system will then analyze the user's login credentials and set restrictions 205. If a user has appropriate access to the business process management system, the system may allow users to access different process data and task data, which may be stored on a server or local computer.

In one example, a high-level internal administrator may login. After logging in, the system will analyze the administrator's login credentials. A high-level administrator may have the fewest restrictions within the business process management system. In this scenario, the high-level administrator will be allowed to view, change, or delete almost all or all of the data affiliated with the business process management system.

In another example, a low-level functional contractor from an outside company may log in to the business process management system. Once the contractor successfully logs in, the business process management system will analyze the contractor's login credentials and set restrictions. A low-level functional contractor may be granted the least amount of freedom within the business process management system. A process creating entity (such as, but not limited to, a project manager) may not want a low-level functional contractor to view all the tasks within a process. Therefore, the system can be configured to set restrictions 205 to only allow the contractor to view relevant processes and tasks and to disable any alterations of specified data. This allows a corporation to have a peace of mind when allowing outside contractors access to important business processes within a business process management system.

In another exemplary embodiment, the business process management system may set restrictions 205 on critical data. Critical data can be described as data which has no purpose in being altered or removed. Critical data may be data of high importance or low importance, however, one purpose of critical data is to be stored in the business process management system with no modifications. In order to prevent accidental alterations or removal of critical data, the business process management system can provide universal restrictions on critical data to all users. An administrator or another user (such as, but not limited to, a process-creating user) may determine what process or task data is critical data. Additionally an algorithm can calculate which critical data to flag. Once the critical data has been flagged, it may be restricted from alteration or removal. This could include user access processes whereby audit data must not be removed or tampered with during its retention period.

In addition to setting restrictions 205, the business process management system may locate relevant process data in the database, also defined as “setting” the process 207. In order to set the process 207, the system analyzes login credentials and locates all the process data 105 affiliated with the user. The system may analyze the entity, functional group, business relationship, etc. in order to determine which processes are available for viewing or modification. By limiting the processes based on the user's login credentials, the interface of the business process management system is simplified by eliminating the option to view processes that are irrelevant. Additionally, filtering the process based on the user's login credentials creates security restrictions for competitive outside corporations from viewing different processes within a common customer. In one example, a high-level internal administrator may have access to all processes within the system. This may allow the administrator to view the all past, present, and future processes within an entity to ensure efficiency. This may also allow the administrator to effectively see the life-cycle of a process to determine where improvements can be made.

In another example, a low-level functional contractor from an outside company may only be able to locate the processes on which they are currently working. This will allow the corporation to minimize the confusion of a contractor's agenda with a business process. The restrictions also serve as a guidance mechanism for the contractor to complete his tasks.

In another example, an executive from an outside supplier may be allowed to view all processes that the supplier is working on. This may allow the executive to view the supplier's current involvement and relationship with the corporation. Additionally, this may allow the executive to effectively communicate to his management staff key areas management should focus their efforts in order to establish a stronger working relationship with the corporation.

The business process management system also associates task data 209 with the process data 105. The business process management system may analyze the different process data and associate task data 209 with the process based on factors including but not limited to the process, user, entity, etc. By automatically associating task data 209 with the process data 105, consistency and efficiency of the business process management system is achieved. Entities can be assured that common processes are used throughout different departments, corporations, and other entities. Additionally, the task data 117 can automatically be assigned to an individual user in order to delegate tasks to the appropriate user. The task data 117 can also be automatically assigned a due date based on, for example, without limitation, known timeframes or expectations for a given common task's completion.

For example, without limitation, all business processes input by a senior engineer may require review and approval by a senior engineer manager before the rest of the process can proceed. It may also be reasonable to expect this approval to take no longer than three days. Thus, if a user with “senior engineer” affiliated credentials input a business process, the system may automatically assign an “Approval” task to the process and assign a timeframe of three days for process completion. Additionally, the system could provide any user with “senior engineer manager” credentials who logged into the system access to all tasks designated for completion by a senior engineer manager. In another exemplary embodiment, the task may be assigned to a specific engineer manager, and only that manager could access the specific task.

One method of associating the task data 209 from the business process data 105 may be to apply an algorithm based on various factors. In an illustrative embodiment, the algorithm can use factors such as, but not limited to, the process, user, creation date, entity name, entity type, functional group, etc. By applying the algorithm, the business process management system may be able to identify certain tasks to be automatically associated with a particular business process. The task data 117 may then be associated with the given process. Additionally, the task data 117 may be affiliated with a user based on their log-in credentials and security restrictions.

Another method of associating the task data 209 with the business process data 105 may be having a user individually input tasks. For example, if a new process is created, the business process management system may not know exactly what tasks to associate with the process. Therefore, a user with sufficient understanding of the whole process may assign task data to the process. For example, if a new process is established within an entity, a high-level administrator may be required to manually input each task of the process. After a user initially assigns the tasks to the process, the algorithm may be utilized to associate the task data 209 to the process. After tasks are assigned to a business process, the system is capable of allowing a user to conduct a task query 211. A task query 211 allows retrieval of information (such as, but not limited to, task data 117) related to a process. The task query 211 allows the user to input a description to permit the business process management system to understand what process-related data the user wants to retrieve. The task query 211 results can be output to different electronic devices 101. The task query 211 results for the same task/process may be different for each user based on restrictions set on the business process management system for the various users.

In one illustrative embodiment, the task query 211 is capable of retrieving information by filtering certain attributes for which a user is specifically searching. Filtering the task query 211 allows a user to efficiently retrieve information related to a specific task or instance. Filtering allows the business process management system to retrieve information based on specific information of specific attributes. Specific attributes which are filterable may include, but are not limited to, an identification number, identification name, process name, time, due date, status, error notification, etc.

Once a task query 211 is complete, a user can choose to view more detail 213 regarding a task, exit the business process management system, etc. If a user chooses not to utilize the task query, the application may end.

If a user elects to view more detail 213 regarding a task, the output device may show task details 215 to the user. Task details 215 provide very specific information regarding a task. In one embodiment, the task details 215 may include, but are not limited to, displaying all the tasks in a process, the task subject, owner, status, creation date, due date, closing date, and task ID. Additionally, the ability to delve into the details surrounding the instance including the business data carried through the process is enabled at this point if the user is allowed to view that context. The task detail also allows users to go back to the task query or complete the task detail and exit the business process management system.

Referring now to FIG. 2B, the flow chart displays an exemplary method of how different parties having different roles can monitor an ongoing process. The process may receive a data request from a requesting party. The process may also filter the business process data based on the designated party role. After analyzing the requesting party's role, the embodiment may designate the requesting party three different roles for a monitoring party that is unassigned to complete any of the tasks in the business process. In one illustrative embodiment, a requesting party may try to retrieve task data with designated role information 261. The task data is designated its corresponding role information by a non-monitoring party. The task data may describe each task involved and the role and responsibilities assigned for each task. The process may analyze the requesting party's role to view the task data in step 263. If a requesting party does not have any access to view data they may be directed to request access 265 from an administrator or another party. If the requesting party has access to view the task data, the requesting party's access to edit data is analyzed in step 267. In one non-limiting example, a requesting party may have access to view data. However, the requesting party may not have access to edit data. Therefore, the system will only set access to view data 269. The requesting party may be able to view identities of parties responsible for the task and the state of completion of the task. If a requesting party does have access to edit data, process will set access to view and edit data 270. The process may furthermore analyze the requesting party's access to all data 271. If a requesting party does not have access to all data, step 273 will limit data access to only the permissible scope of the requesting party. When a requesting party does have access to all data, step 275 sets full access to all data for the requesting party. The process may then check the request based on access permission 277. The process may then analyze whether the request is valid 279. When a request is not valid, the process will exit. When the request is valid, the process will return the requested data to the party. If appropriate, the requesting party may view and edit the data 281.

Different requesting parties may have different rights. For example, a requesting party with both viewing and editing rights may have more access to view more detailed data than a different requesting party with only viewing rights. The requesting party with both viewing and edit rights may be allowed to view such information as, but not limited to, the creator of the task and the date the task was created. For example, in one non-limiting embodiment, a manager may have access to view and edit the task data applicable to his area's responsibility. However, the manager may not be allowed to edit or view data from another department. The manager may also have more viewing capability than an outside contractor hired to complete a task of the process.

Another illustrative example of a requesting party's monitoring role is a party who may have access to view, but not edit, data. An example may be the management affiliated with an outside contractor. An outside contractor may be hired by a company to perform a certain task of a process. The manager of the outside contractor may need to know the contractor's duties in order to assess the performance of the contractor. However, the company may not want the outside contractor to view all the data of the system. Additionally, the company may not want the manager to change any tasks affiliated with the contractor's duties. Therefore, the manager of the outside contractor may be assigned a role that does not allow the manager to change the contractor's task or view other parties' tasks during the process.

In another non-limiting example, a requesting party may have access to view and edit all data. The high level administrator may be able perform certain functions of monitoring the data, including but not limiting to, changing the data defining the task, reassigning the task to another party, or removing the task from the system. In one example, an executive level administrator may be able to view all task data associated with the executive's company. The executive can delete tasks or reassign tasks to different management or outside contractors. This allows the executive to monitor the performance of all the company's tasks, and to make changes in task allocation performance is not met.

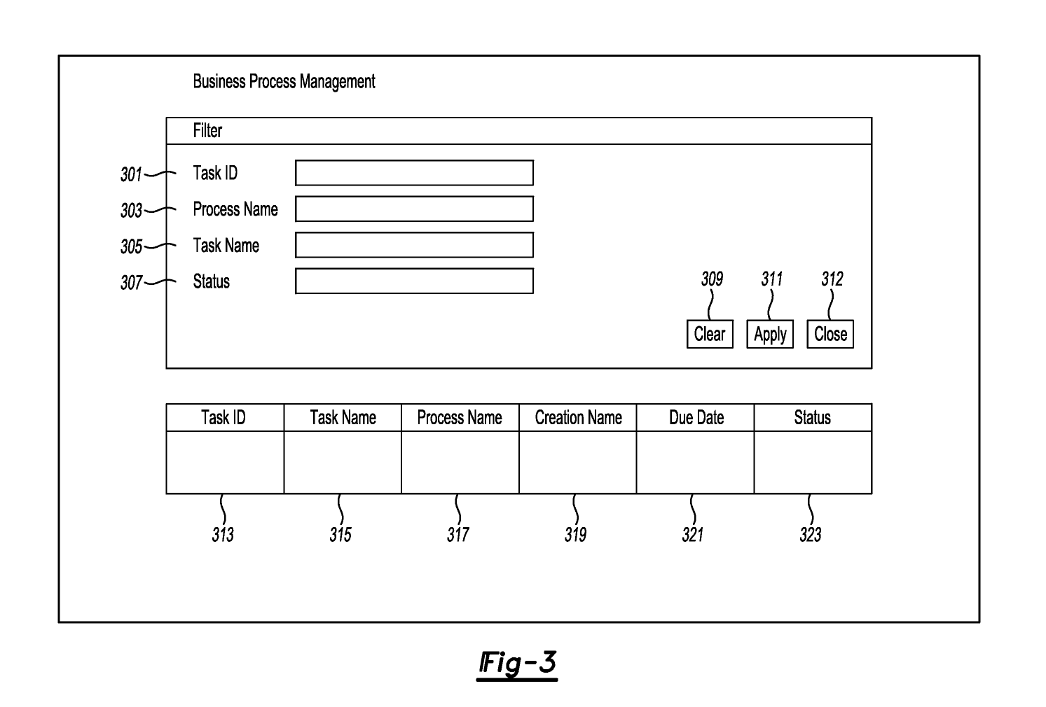

Referring now to FIG. 3, the example screen shot displays an exemplary business process management system task query in detail. In one illustrative embodiment, the task query screen is capable of filtering business process data by the task ID 301, process name 303, task name 305, and status 307. The task ID 301 can be any identification number that is associated with a task. The process name 303 can include an alpha-numeric title for the general process. The task name 305 can include an alpha-numeric title for the specific task associated with the process. The status 307 can include information of a task or process's progress. For example, without limitation, the status 307 can include whether a process or task is complete, in progress, failed, received an error, canceled, etc. The user may be allowed to input into the data fields. Additionally, the user can click “apply” to begin the filtering process of the data field. The user may also have the option to exit out of the task query by pressing the close button.

Once the filter is applied, the application will generate the appropriate filtered data to output to the user. In the illustrative embodiment, once the filtering is applied, users are able to search through the filtered data fields via the task ID 313, task name 315, process name 317, creation time 319, due date 321, status 323, etc.

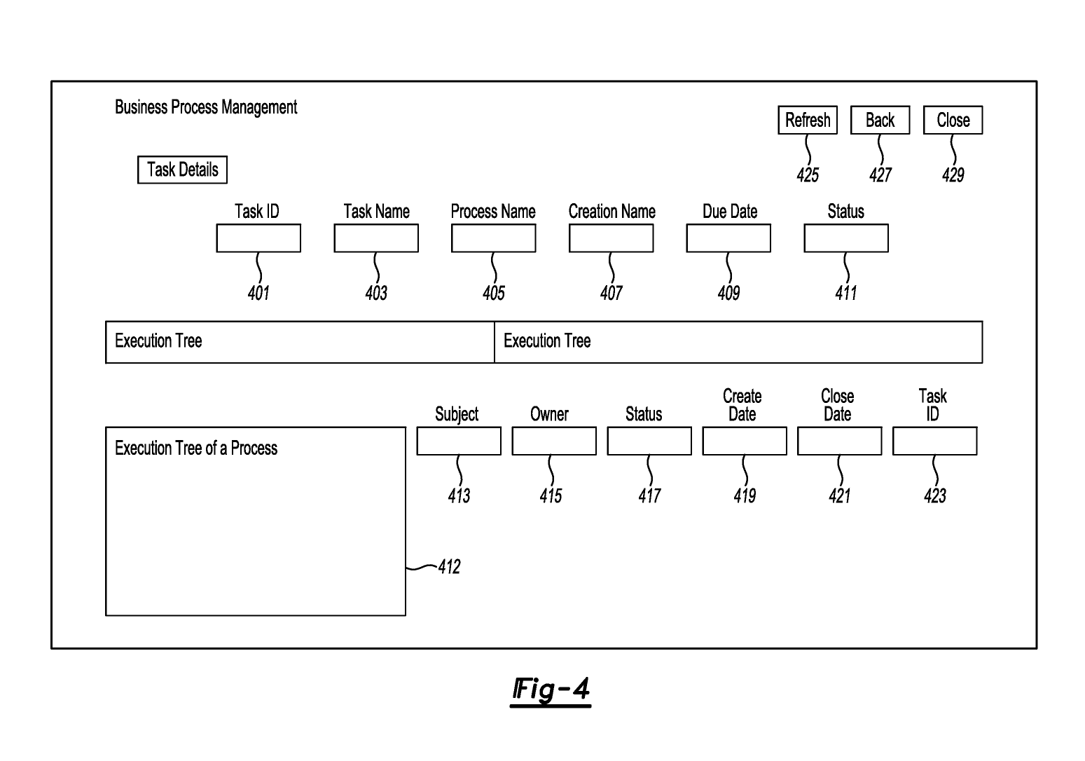

Referring now to FIG. 4, the example screen shot exhibits an illustrative business process management system's task detail screen. The task detail screen is configured to display all information that is affiliated with the process data 105 and task data 117. The task detail screen may allow users to supervise an activity from start to finish. Additionally, it can output more detail regarding each process or task. In an illustrative embodiment, the task details screen may include information such as, but not limited to, a task ID 401, task name 403, process name 405, creation time 407, due date 409, status 411, etc.

The business process management system's task detail screen may also show an execution tree 412 of a process. The execution tree 412 may show all of the tasks involved in a process. The list can be displayed as a collapsible tree. Additionally, the execution tree can display only a limited view of tasks due to security restrictions. The execution tree 412 may allow a user to further select a different task from the process to display details regarding the task. In an illustrative embodiment, the execution tree 412 may include information such as, but not limited to, a subject 413, owner 415, status 417, create date 419, close date 421, task ID 423, etc. The execution tree may also allow an authorized user to further view or change business data within the process specified by the original process design. This data includes, but is not limited to, user name, comments, routing information, customer address info, etc.

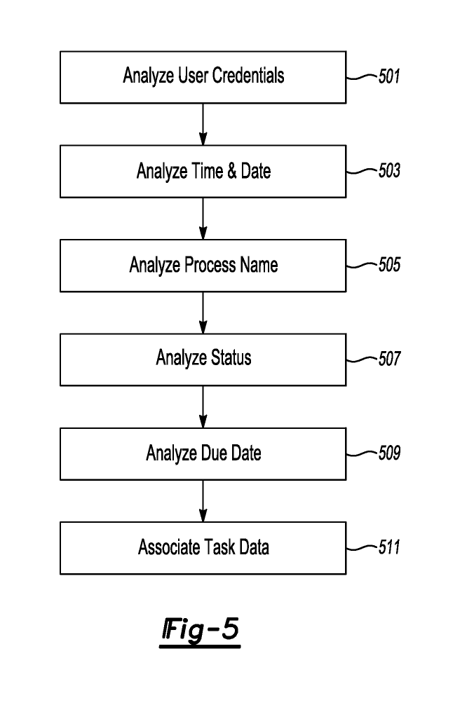

Referring now to FIG. 5, the association of the task data with the process data is exemplified in the algorithm. The association of data may be internal or originate from external applications. In the illustrative embodiment, a possible step of associating the task data with the process is analyzing the user credentials 501. By understanding what user credentials are accessing the process data, the algorithm can assign specific tasks. For example without limitation, if a working-level functional employee logs in, that employee's task data can be related to all functional tasks the employee must complete during the process.

A possible step of the algorithm can also include analyzing a current time and date 503 with respect to the process data. Time and date information can be associated with the task data in order to associate tasks which are available in specific time frames. For example without limitation, production of a product may be shutdown in a specific time frame for a process. The algorithm can determine that the task is not capable of being completed in the time frame that production is shut down. Additionally, the algorithm can assign a different task in order to achieve efficiency of the product. Furthermore, the time and date attributes can determine prioritization order when associating task data which has yet to be completed based on the time and date.

Another possible step of the algorithm is to analyze a process name 505. By analyzing the process name 505, the application can compare the process name with the typical task associated with that process. For example without limitation, if the process name is “Interview potential employee”, the algorithm can analyze the process name and determine that the task data associated with the process may be data in the form of creating a questionnaire list, scheduling phone interview, scheduling a face to face interview, and analyzing candidates with management. The application may use standardization and matching logic in the event a user misspells a process name.

An additional step of the algorithm can include analyzing a status 507. Analyzing the status 507 can allow the task data to be adjusted based upon the state of a process. For example, if a process has failed, the task data associated with the process may be different than a process which has not failed. A failed process may want to associate task data related to recovery, troubleshooting, and future prevention of the failure. Another example of analyzing the status 507 may include a status which determines that a process or task is complete. If the algorithm views a complete status, it may associate task data which determines a set of tasks to review the completed process or other tasks involved after completion of a project.

Another step of the algorithm can include analyzing a due date 509 of the process. For example without limitation, a task or process that is overdue may have new associated tasks to recover the lost time of the overdue process. Due date information can be useful to prioritize task data that should have been completed or that is overdue. Additionally, a project which is overdue may require additional tasks to recover lost time.

Furthermore, the algorithm may be able to prioritize data based on the due date. Prioritizing data can be done in a number of ways. For example, without limitation, the application can set a flag to prioritize a process or task, display a graphical indicator, generate a warning message for a high priority item, generate an email to applicable users, etc.

Finally, after all the attributes of the process data are analyzed, the application may automatically associate task data 511 with the process. The association of the task data 511 can also be done via a look-up table, modified algorithm, manual input, etc. For example, by utilizing a look up table, the application can identify attributes in the process data that are always associated with the task data. If the application refers to the look up table, it can quickly associate the relevant task data to the process.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A computerized method for monitoring a business process including a plurality of tasks, in which business process data relating to the business process of a manufacturer business entity and task data relating to the plurality of tasks related to a supplier business entity of the manufacturer business entity are stored in memory of a computer, each of the plurality of tasks having one or more task completion parties of the supplier business entity assigned to complete the respective tasks associated therewith by the manufacturer business entity, comprising:
receiving a data request with the computer, from a requesting party who is not one of the task completion parties assigned to complete any of the tasks for which the data request was made and who is part of the manufacturer business entity, the data request including one or more user credentials designating a role of the requesting party;
defining the task data with the computer and without manual input from an administrator, the defining step including automatically associating the task data with the process data without human intervention;
filtering with the computer, business process data and task data based at least in part on the role of the requesting party, the filtering including,
for a first requesting party having a first monitoring role, automatically designating with the computer and without manual input from the administrator a first level of access limited to viewing of the task data for one or more but not all of the plurality of tasks, and
for a second requesting party having a second monitoring role, automatically designating with the computer and without manual input from the administrator a second level of access as viewing and editing the task data for one or more but not all of the plurality of tasks, and
for a third requesting party having a third monitoring role, automatically designating with the computer and without manual input from the administrator a third level of access as viewing and editing the task data for all of the plurality of tasks; and
returning the requested data with the computer, to the requesting party based upon the requested data meeting the level of access automatically designated by the computer and without manual input from the administrator based on at least the user credentials defining the role of the requesting party to provide the requesting party, who is part of the manufacturer business entity, enhanced monitoring capabilities of the business task data associated with the respective tasks assigned by the manufacturer business entity to be completed by the one or more task completion parties of the supplier business entity.

2-9. (canceled)

10. A computerized system for monitoring business process management comprising:
electronic storage device including business process data and a plurality of task data related to the business process data and defining a plurality of tasks to complete one or more business processes of a manufacturer business entity, the plurality of tasks relating to a supplier business entity of the manufacturer business entity having one or more task completion parties of the supplier business entity assigned to complete the respective tasks associated therewith by the manufacturer business entity;
processor configured to execute one or more applications;
a non-transitory application stored in memory and configured to execute the following steps when the application is executed by the processor:
receive a data request from a requesting party, including one or more user credentials designating a role of the requesting party, wherein the requesting party is not one of the task completion parties and who is part of the manufacturer business entity;
define the task data without any manual input from an administrator and automatically associating the task data with the process data without human intervention;
filter business process data and task data based at least in part on the role of the requesting party, including,
for a first requesting party having a first monitoring role, automatically designating without manual input from the administrator a first level of access limited to viewing the task data for one or more but not all of the plurality of tasks, and
for a second requesting party having a second monitoring role, automatically designating without manual input from the administrator a second level of access as viewing and editing the task data limited to one or more but not all of the plurality of tasks, and
for a third requesting party having a third monitoring role, automatically designating without manual input from the administrator a third level of access as viewing and editing the task data for all the plurality of tasks;
return the requested data to the requesting party based upon the requested data meeting the level of access automatically designated without manual input from the administrator for the requesting party based on at least the user credentials defining the role of the requesting party to provide the requesting party, who is part of the manufacturer business entity, enhanced monitoring capabilities of the business task data associated with the respective tasks assigned by the manufacturer business entity to be completed by the one or more task completion parties of the supplier business entity.

11. (canceled)

12. The system of claim 10, wherein the application is further configured to filter such that viewing task data includes viewing a state of completion of the task.

13. The system of claim 10, wherein the application is further configured to filter such that editing task data includes changing the data defining the task.

14. The system of claim 10, wherein the application is further configured to filter such that editing task data includes reassigning the task to one or more new parties.

15. The system of claim 10, wherein the application is further configured to filter such that editing task data includes terminating a task.

16. The system of claim 10, wherein the application is further configured to filter such that viewing access of at least the second or third party is broader in scope than the viewing access of the first party, and includes at least a right to view additional data not visible to the first party.

17. The system of claim 16, wherein the application is further configured to filter such that the additional data includes a task creator.

18. The system of claim 16, wherein the application is further configured to filter such that the additional data includes a task creation date.

19. A non-transitory computer readable storage medium storing business process data and a plurality of task data related to the process data and defining tasks related to a supplier business entity of a manufacturer business entity to complete one or more business processes of the manufacturer business entity, the tasks having one or more task completion parties of the supplier business entity assigned to complete the respective tasks associated therewith by the supplier business entity, and storing instructions that when executed by a processor causes the processor to perform a method comprising:
receiving a data request from a requesting party who is not one of the task completion parties assigned to complete any of the tasks related to the business process for which the data request was made and who is part of the manufacturer business entity, the data request including one or more user credentials designating a role of the requesting party;
defining the task data without manual input from an administrator, the defining includes automatically associating the task data with the process data without human intervention;
filtering business process data and task data based at least in part on the role of the requesting party, the filtering including,
for a first requesting party having a first monitoring role, automatically designating without manual input from the administrator a first level of access limited to viewing of the task data for one or more but not all of the plurality of, and
for a second requesting party having a second monitoring role, automatically designating without manual input from the administrator a second level of access as viewing and editing the task data limited to one or more but not all of the plurality of tasks, and
for a third requesting party having a third monitoring role, automatically designating without manual input from the administrator a third level of access as viewing and editing task data for all of the plurality of tasks; and
returning the requested data to the requesting party based upon the requested data meeting the level of access automatically designated without manual input from the administrator for the requesting party based on the user credentials defining the role of the requesting party to provide the requesting party, who is part of the manufacturer business entity, enhanced monitoring capabilities of the business task data associated with the respective tasks assigned by the manufacturer business entity to be completed by the one or more task completion parties of the supplier business entity.

20. The computer readable storage medium of claim 19, wherein viewing task data includes viewing identities of the one or more parties assigned to complete the task.

21. The method of claim 1, wherein the task completion party, the first requesting party, the second requesting party, and the third requesting party are distinct from one another.

22. The method of claim 1, wherein each of the first, second, and third requesting parties do not have any task completion responsibility.

23. The method of claim 1, wherein the step of defining the task data includes utilizing the one or more user credentials of the requesting party.

24. The method of claim 1, wherein the step of the defining of the task data is accomplished utilizing a process name of the process data.

25. The method of claim 1, wherein the step of the defining of the task data is accomplished utilizing a due date related to the process data.

26. The method of claim 1, wherein the step of the defining of the task data is accomplished utilizing a condition-state related to the process data.

27. The method of claim 1, wherein the task data includes critical data that cannot be altered or removed regardless of the level of access of the requesting parties.

28. The method of claim 27, wherein the critical data is audit data that cannot be altered during a specific retention period.

29. The method of claim 1, wherein the step of defining the task data associated with the process data utilizes the process, user, creation date, entity name, entity type, or functional group of the process data.
